(19) United States
(12) Patent Application Publication
(10) Pub. No.: US 2003/0204376 A1
(43) Pub. Date: Oct. 30, 2003

(54) Interactive electronic device

(75) Inventors: Shinichi Obata, Fujisawa (JP); Hiroshi Shimizu, Yokohama (JP); Masahiko Saito, Mito (JP); Atsushi Ogino, Kodaira (JP); Jun Maeoka, Kawasaki (JP); Nobuaki Kohinata, Yokohama (JP)

Correspondence Address: Steve Y. Cho, Townsend and Townsend and Crew LLP, 8th Floor, Two Embarcadero Center, San Francisco, CA, 94111, US

(73) Assignee: Hitachi, Inc., Tokyo (JP)

(21) Appl. No.: 10/357,707

(22) Filed: Feb. 3, 2003

(30) Foreign Application Priority Data
Apr. 19, 2002 (JP) 2002-116978

(51) Int. Cl. G06F 11/00; G06F 15/00

(52) U.S. Cl. 702/188

(57) ABSTRACT

A method for operating an electronic device includes detecting a condition associated with the electronic device that affects a performance of an operation by the electronic device; and transmitting a condition report to a remote electronic device, the condition report including a request to perform the operation.

### CROSS-REFERENCES TO RELATED APPLICATIONS

The present application is related to and claims priority from Japanese Patent Application No. 2002-116978, filed on Apr. 19, 2002.

### BACKGROUND OF THE INVENTION

The present invention relates to an electronic device equipped with a communication interface that communicates with other devices.

As a prior art, JP-A No. 55496/1998 discloses an electronic device equipped with a communication function that monitors inside/outside conditions of a device, picks up an error condition, and reports it to its user. Specifically, the prior art discloses a device that monitors internal and external conditions of an automobile, detects an error condition, reports it to a driver who then executes an appropriate countermeasure against the error.

In the prior art device, when an error condition is detected, the device either automatically executes a countermeasure against the error or waits for the driver to provide an appropriate command with a remote control. However, when the device itself malfunctions, the prior art provides no means of taking countermeasures.

### SUMMARY OF THE INVENTION

In one embodiment of the present invention, an electronic device is configured to report its own problem to another device, so that any unperformed functions may be performed by another device.

In one embodiment, a method for operating an electronic device includes detecting a condition associated with the electronic device that affects a performance of an operation by the electronic device; and transmitting a condition report to a remote electronic device, the condition report including a request to perform the operation.

In another embodiment, a method of operating an electronic device system including a plurality of electronic devices is disclosed. The method includes detecting a condition associated with a first electronic device that affects a performance of an operation by the first electronic device; and transmitting a first condition report to a second electronic device by the first device, the first condition report including a request to perform the operation.

In another embodiment, a method of operating an electronic device includes detecting an error condition associated with the electronic device that prevents the electronic device from performing an operation; and transmitting a condition report to a remote electronic device, the first condition report requesting the remote device to perform the operation.

In another embodiment, an electronic device includes a processor to control an operation of the electronic device; a sensor to detect a condition associated with the electronic device; a communication interface to communicate with a remote device; and a first memory to store computer readable instructions, the memory including code for transmitting a condition report to a remote electronic device if the sensor detects a condition associated with the electronic device that affects a performance of an operation by the electronic device, the condition report including a request to another device to perform the operation.

In yet another embodiment, an electronic device includes a processor to control an operation of the electronic device; a sensor to detect a condition associated with the electronic device; a communication interface to communicate with a remote device; a first memory to store machine readable instructions, the memory including code for transmitting a condition report to a remote electronic device if the sensor detects a condition associated with the electronic device that affects a performance of an operation by the electronic device, the condition report including a request to another device to perform the operation; and a second memory configured to select countermeasure information according to the condition associated with the electronic device.

In yet another embodiment, a machine readable medium for operating an electronic device provided in a network system including a plurality of electronic devices is disclosed. The medium includes code for detecting a condition associated with a first electronic device that affects a performance of an operation by the first electronic device; and code for transmitting a first condition report to a second electronic device by the first device, the first condition report including a request to perform the operation.

### BRIEF DESCRIPTION OF THE DRAWINGS

FIG. 1 is a block diagram of a structure of an electronic device in a first embodiment of the present invention.

FIG. 2 is a flowchart of a method of reporting an error of the electronic device in the first embodiment of the invention.

FIG. 3 shows examples of error report data sets used in reporting the error of the electronic device in the first embodiment of the invention.

FIGS. 3(a), (b), and (c) are the configurations of the error report data sets.

FIG. 3(d) is an example of the error report data set when an error occurs in a video cassette recorder.

FIG. 4 is a block diagram showing a structure of an electronic device in a second embodiment of the invention.

FIG. 5 shows examples of error data sets used in reporting an error of the electronic device in the second embodiment of the invention.

FIGS. 5(a) and (b) are the configurations of the error report data sets.

FIG. 5(c) shows examples of countermeasures or answers for the report data set.

FIG. 6 is a block diagram showing a structure of a mobile communications terminal as an electronic device in the second embodiment of the invention.

FIG. 7 is an example of use of the electronic device in the first or second embodiment of the invention.

FIGS. 8(a)-8(d) show examples of a screen display of the mobile communications terminal in the second embodiment of the invention.

### DETAILED DESCRIPTION OF THE PREFERRED EMBODIMENTS

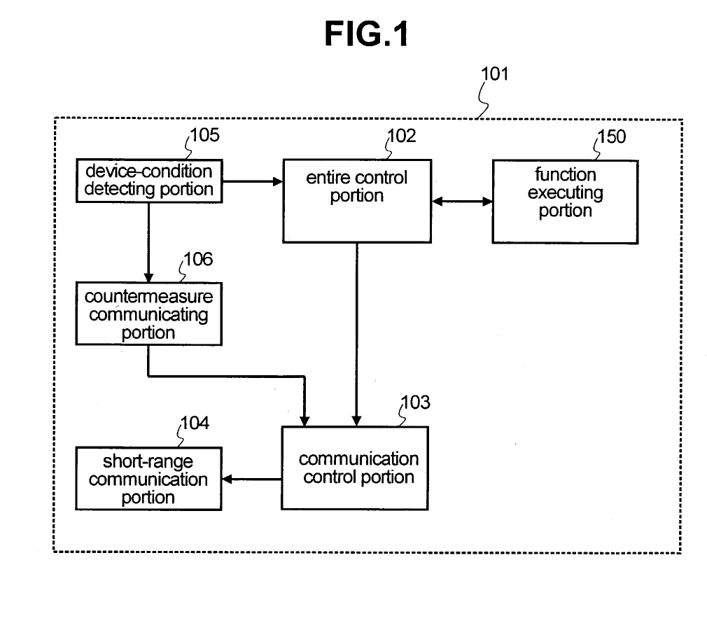

The preferred embodiments of the invention will be described below with reference to FIGS. 1 to 8. An electronic device having an information report function in the following embodiments can report to other devices its own condition, such as failure, error, completion or end of an operation, and other informative information.

A first embodiment of the invention will be described with reference to FIGS. 1 to 3, and 7. FIG. 1 is a block diagram showing a basic structure of an electronic device 101 having a short distance communication function. The electronic device has a function that automatically communicates with other devices within an area such as a home, an office, or a shop. More specifically, the device may be one of the followings: a home electric appliance having a short-range communication function, such as, a video cassette recorder (VCR hereinafter), a washing machine, a digital video disk (DVD hereinafter) recorder, a hard disk recorder, and a refrigerator; an office device having a close distance communication function, such as, a facsimile, a copier, and a printer; and a shop device having a short-range communication function, such as, a cash register, a refrigerated showcase, and a monitor camera. The above electronic devices are merely provided as examples. The devices of the invention are not limited to these devices.

As shown in FIG. 1, the electronic device 101 has a device-condition detecting portion 105, a countermeasure communicating portion 106, and a communication control portion 103. In one embodiment, the device-condition detecting portion 105 is as a sensor that detects an internal condition such as an error and determines the error type. The countermeasure communicating portion 106 is a memory used as a selector that selects countermeasure information according to the error condition experienced by the device. The communication control portion 103 configures information including a device ID for identifying a device, a condition of the device, and countermeasure information, as a condition report data set, and controls a transmission of a short-range transmission portion 104. The short-range transmission portion (or data transmitter) 104 transmits a condition report data set to one or more devices. The data transmitter 104 may be a wireless LAN, a short-range radio, and an infrared data transmission (e.g., BLUETOOTH™). The electronic device 101 also has a function executing portion 150 and a total control portion 102. Assuming that the device is a VCR, the function executing portion (or controller) 150 executes a function of the device such as a video recording and playback function. The total control portion 102, such as a CPU, controls the whole device including the communication control portion 103 and the function executing portion 150. Incidentally, the countermeasure communicating portion 106 is provided with a countermeasure information table that stores countermeasure information. In this embodiment, the countermeasures against a detected error are mainly described, but the invention is not limited to this feature.

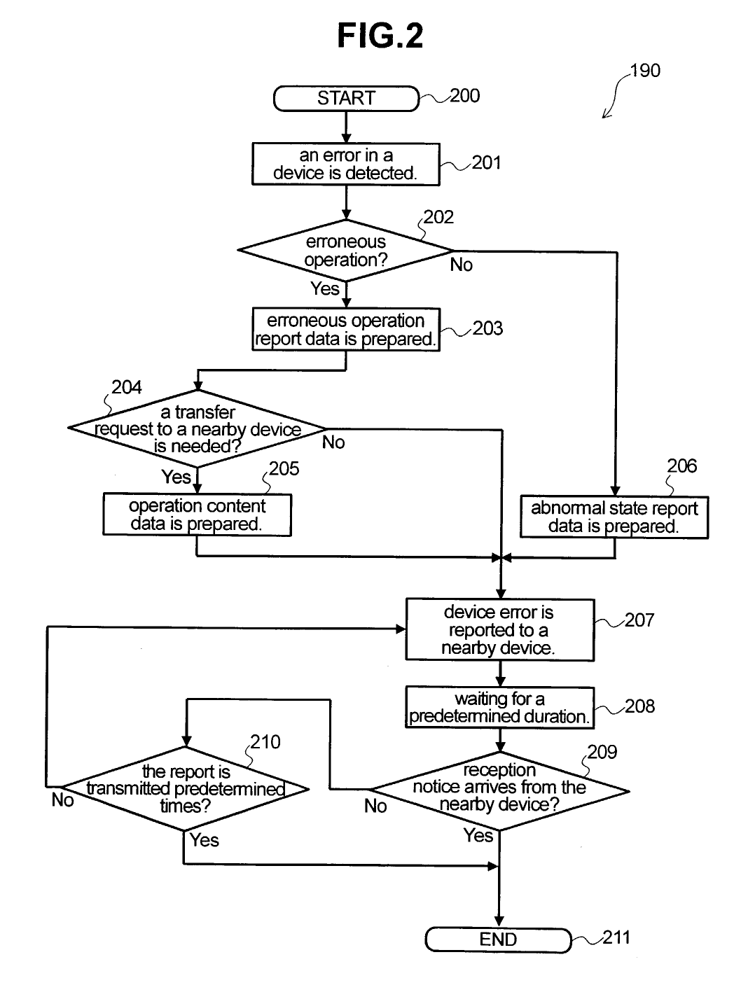

When the device-condition detecting portion 105 detects an error, the countermeasure indicating portion 106 executes a countermeasure according to the error type. FIG. 2A shows a flowchart of a process 190 according to one embodiment of the present invention. The steps 202 to 211 are performed by the countermeasure communicating portion 106 in the present embodiment. Initially, the device operates normally (step 200). When the device-condition detecting portion 105 detects an error in the device 101 (step 201), the countermeasure communicating portion 106 determines whether the error is a failure state in which certain operations of the device 101 cannot be performed or an abnormal state in which the device 101 is merely in a state that is not normal (step 202). In this embodiment, the countermeasure communicating portion 106 determines the error is an abnormal state when the error does not effect a desired operation of the device. When the error is determined to be a failure in step 202, the erroneous operation report data is prepared in step 203. In step 204, the countermeasure communicating portion 106 determines whether a transfer request (secondary request) to a nearby device is needed for the erroneous operation. When the transfer request is needed, this process goes to step 205 to prepare data representing the operation contents. In step 207, the data representing the operation contents is transmitted as the error report to the nearby device. After waiting for a predetermined duration in step 208, the countermeasure communicating portion 106 determines whether there is an acknowledgement from the nearby device in step 209. When there is no acknowledgement from the nearby device, the countermeasure communicating portion 106 determines, e.g., using a counter, whether the error report has been transmitted to the nearby device for a predetermined number of times in step 210. When the error report has not been transmitted for the predetermined number of times, the countermeasure communicating portion 106 returns to step 207 to transmit the error report to the nearby device again. When an acknowledgement is received from the nearby device, the process 190 proceeds to step 211 and is concluded.

Similarly, referring back to the step 210, if the countermeasure communicating portion 106 determines that the error report has been transmitted to the nearby device for the predetermined number of times, the process goes to step 211 and is concluded.

Referring back to the step 202, the countermeasure communicating portion 106 proceeds to step 206 to prepare the abnormal condition report data when the error is determined to be an abnormal state in step 202. The abnormal condition report data is then transmitted at the step 207. The countermeasure communicating portion 106 determines an error to be an abnormal state if the error does not effect the function or operation to be preformed by the device, so that another device does not need to perform such an operation in place of the device in question.

If the nearby or alternate device (the second device) cannot perform, for some reason, the function requested by the original device (the first device) via the report/request sent by the first device at the step 207, the second device transmits a request to yet another device (the third device) to carry out the requested function by the first device, and so on until the function is performed or there is no other available device.

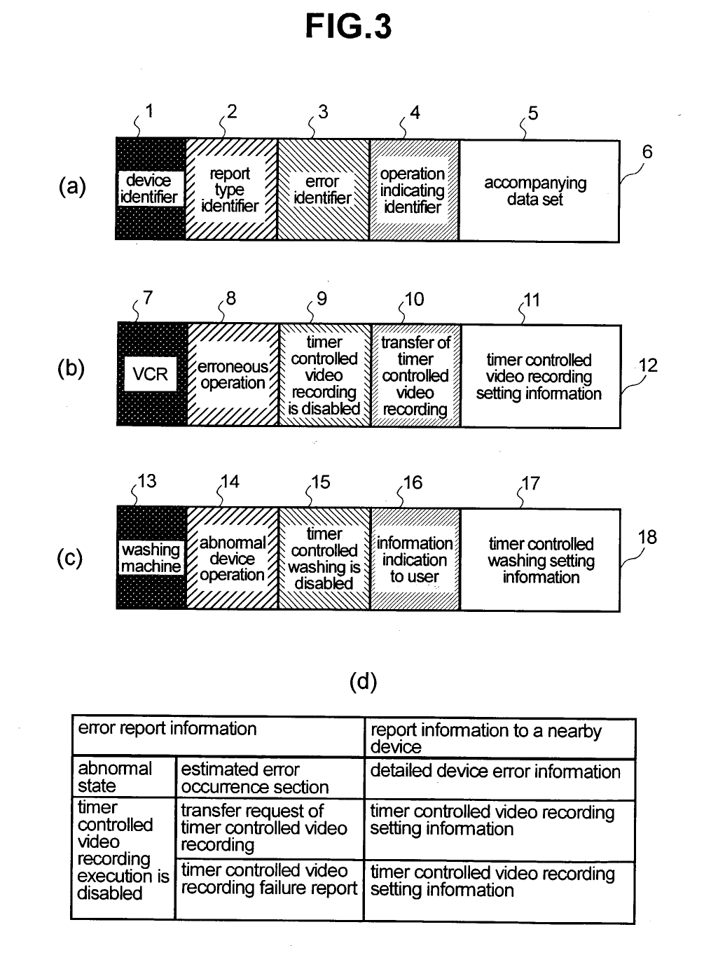

FIG. 3 shows an example of a condition report data set 6. The condition report data set 6, as shown in FIG. 3(a), is configured with a device identifier 1 that identifies the device that is transmitting the report, a report type identifier 2 that indicates a type of the report, an error identifier 3 that indicates a type of the error, an operation indicating identifier 4 that indicates contents of, for example, an alternative operation a nearby device is requested, and accompanying data 5 that stores additional information required for the alternative operation.

A device that includes a function of transmitting an error report according to this embodiment is called a device A (the first device), and a device that receives the error report or request is called a device B (the second device) When an error occurs in the device A, the device A transmits the condition report data set 6 (“condition report”) to the device B. The device B receives the condition report 6 to determine whether the device A is requesting any function to be performed by the device B.

FIG. 3(b) shows an exemplary report data set where the device A is a video cassette recorder (VCR). The data set is configured with a device identifier 7 that indicates that the data set is from a VCR, a report type identifier 8 that indicates the device erroneous operation, an error identifier 9 that indicates that a timer controlled video recording is disabled, an operation indicating identifier 10 that indicates a transfer request of the timer controlled recording to another device, and accompanying data 11 that stores timer controlled video recording setting information required for the timer controlled video recording. For example, a VCR, a DVD recorder, a hard disk recorder, a television, and a washing machine that can only transmit or both transmit and receive information representing their own conditions are in a home. By receiving the condition report 6 from the device A, the VCR in which error occurs, the device B (e.g., DVD recorder) can recognize what timer controlled video recording to execute, instead of the device A. The device A transmits timer controlled video recording information such as “from 21:00 to 23:00 Jul. 7, 2003; channel 2; normal speed” or “video recording reservation code 123456; triple speed” as the accompanying data.

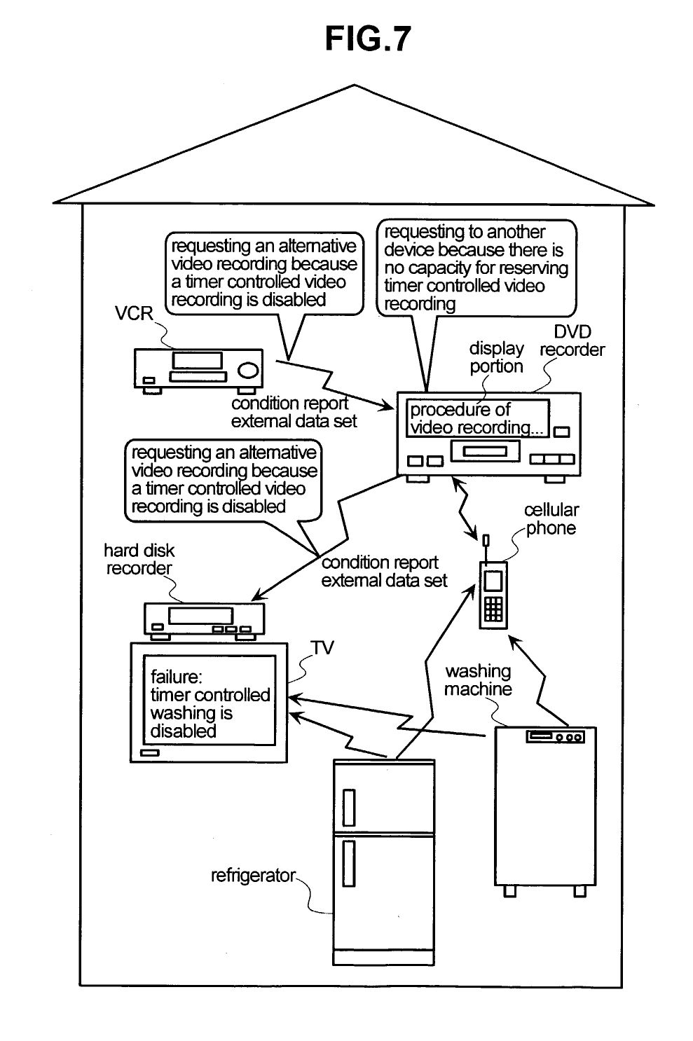

FIG. 3(c) shows an exemplary data set when the device A is a washing machine. A condition report 18 has a device identifier 13 that indicates the data set is from a washing machine, a report type identifier 14 that indicates the abnormal device operation, an error identifier 15 that indicates that timer controlled washing is disabled, an operation indicating identifier 16 that indicates a request of indicating information to a user, and accompanying data 17 of timer controlled washing setting information. Unlike the VCR, the washing machine requests another device to notify the user because laundry needs to be moved for the alternative operation. As shown in FIG. 7, the nearby device B such as a television and a cellular phone receives the condition report 18 from the washing machine in which an error occurs (device A) so that the device B recognizes that the device A requests an error notification to the user. When the device B is, for example, a television, the user recognizes the voice, caption display or screen display of the contents of the condition report 18 that shows that the timer controlled washing cannot be executed. In a case that the device B is a cellular phone, the user recognizes the voice or text or image data of the condition report 18.

FIG. 3(d) shows examples of report data when error occurs in the VCR, i.e., the device A. The respective examples indicate the report data when the device A is in abnormal state and when the device A operates abnormally. When the abnormal state occurs, the abnormal state, the estimated error occurrence section, and the detailed device error information are set as a report type identifier, an error identifier, and accompanying data, respectively. In the case of the erroneous operation (a timer controlled video recording is disabled), the condition report contains an error identifier that indicates the timer controlled video recording is disabled and an operation indicating identifier that indicates a transfer request of the timer controlled video recording. The timer controlled video recording setting information is set as accompanying data. When the device A does not request the transfer of the timer controlled video recording, the timer controlled video recording failure report may be set as the operation instructing identifier, and the device A may instruct a nearby device to inform the user the failure of the timer controlled recording.

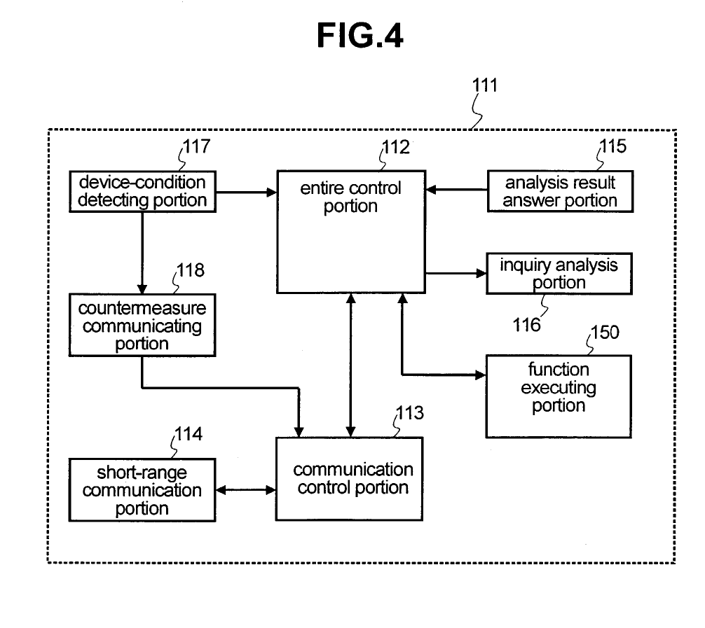

A second embodiment of the invention will be described with reference to FIGS. 4 to 8. FIG. 4 is a block diagram of a basic structure of an electronic device 111 having a communication function that can receive the data set 6. Like the electronic device 101, the electronic device 111 has a device-condition detecting portion 117, a countermeasure communicating portion 118, a communication control portion 113, a short-range communication portion 114, an entire control portion 112, and a function executing portion 150. The electronic device 111 also has an inquiry analysis portion 116 that analyzes and classifies inquiry information which the short-range communication means receives from other devices, and an analysis result answer portion 115 that selects an answer for the classified inquiry information.

In this embodiment, the short-range communication portion 114 includes a function of receiving the condition report 6 from other devices, in addition to the function of transmitting the condition report 6. The communication control portion 113 converts the condition report 6 received by the short-range communication portion 114 to data the entire control portion 112 can recognize, and provides the converted data to the entire control portion 112. Therefore, in this embodiment, signals or data can interact between the short-range communication portion 114 and the communication control portion 113 and between the communication control portion 113 and the entire control portion 112.

As shown in FIG. 4, the entire control portion 112 is coupled to the inquiry analysis portion 116 and the analysis result answer portion 115. The condition report 6 received by the entire control portion 112 is transmitted to the inquiry analysis portion 116. The inquiry analysis portion 116 analyzes information contents contained in the condition report 6 and determines a type of the error and contents of the operation indication. The resulting decision of the inquiry analysis portion 116 is transmitted to the analysis result answer portion 115. Then, the analysis result answer portion 115 selects a countermeasure. Information on the countermeasure selected by the analysis result answer portion 115 is transmitted to the entire control portion 112. The entire control portion 112 controls the function executing portion 150 according to the countermeasure information received from the analysis result answer portion 115.

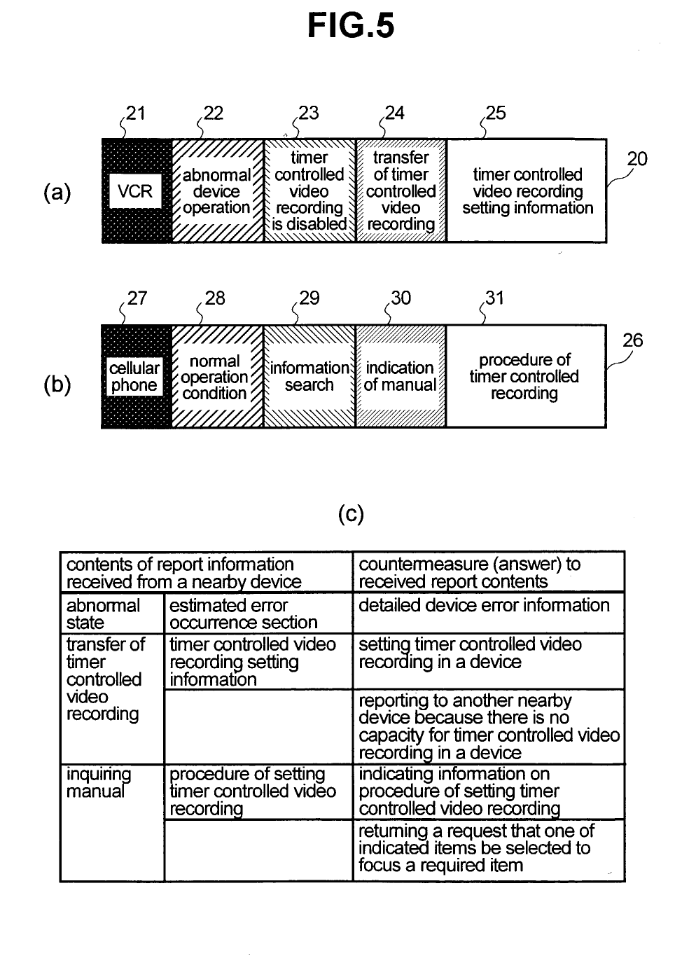

For example, as shown in FIG. 7, when the VCR transmits a condition report data set 20 of FIG. 5(a) to the DVD recorder, the analysis portion 116 of the DVD recorder analyzes the condition report 20 to read information of “timer controlled video recording disabled”, information of “a transfer of a timer controlled video recording”, and timer controlled video recording setting information. When the resulting analysis of the analysis portion 116 determines that the data set 20 requests a transfer of a timer controlled video recording, that is, an alternative timer controlled video recording, the analysis result answer portion 115 prepares to set a timer controlled video recording, so that the electronic device 111 may perform the alternative timer controlled video recording. As described above, according to this embodiment, if a first device cannot perform a requested operation because of an error, a second device is requested to perform the operation, such as a timer controlled video recording. As a result, even when error occurs in a device, a function the user requested can be executed.

As shown in FIG. 7, for example, a cellular phone transmits a report data set 26 of FIG. 5(b) to the DVD recorder to inquire a procedure of the timer controlled video recording.

In this case, an answer for the procedure of the timer controlled video recording is retrieved from a manual database (not shown) in the analysis result answer portion 115 of the DVD recorder. According to an answer method shown in the report data set 26, the short-range communication portion 114 transmits the answer data to a cellular phone, or an information display portion of the DVD recorder displays the answer data. Regardless of contents of the data set 26, the answer method may be fixed previously. The information display portion has, for example, a liquid crystal display device, and displays the operating condition and level of the video recording and playing, the operation mode, and time related information such as date and time. The information display portion of this embodiment has an area that displays previously specified information and an area that displays arbitrary information. The area for previously specified information displays the operating condition, recording and playing level, operation mode, and time related information such as date and time. The area for arbitrary information displays answer data for the received report data set or various messages. In this embodiment, as shown in FIG. 7, the area for arbitrary information displays the answer for the inquiry.

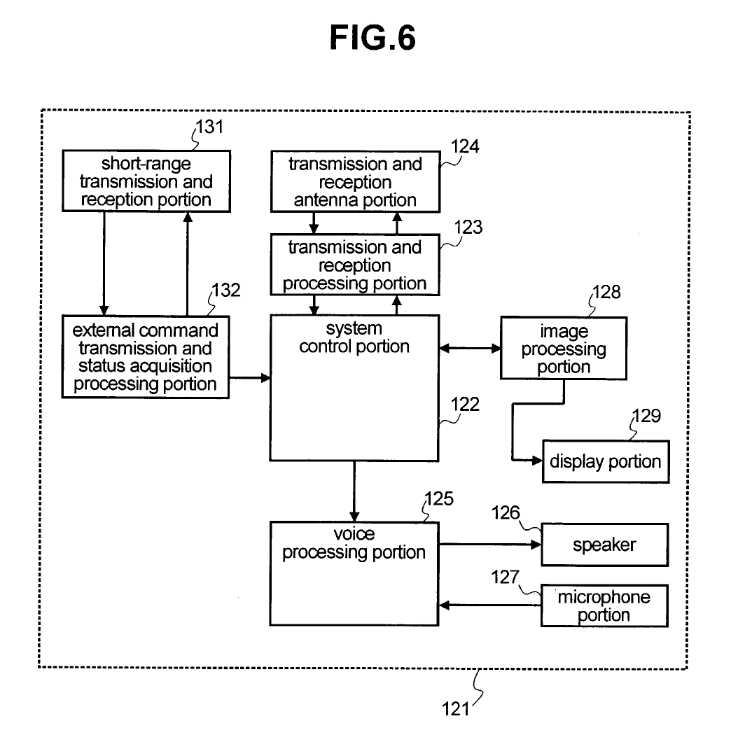

FIG. 6 shows an example of a structure of a communications terminal device, such as, the cellular phone. A communications terminal device 121 has a transmission and reception antenna portion 124 that does a radio transmission and reception, a transmission and reception processing portion 123 that controls the radio transmission and reception, a system control portion 122 that controls the whole communications terminal device, an image processing portion 128 that generates image data, an image data display portion 129, a voice processing portion 125 that generates voice data, a voice output speaker 126, and a voice input microphone portion 127. The communications terminal device 121 further has a short range transmission and reception portion 131 that communicates with other nearby devices and an external command transmission and status acquisition processing portion 132 that receives a report data set from other devices and transmits the report data set to external devices. Although not shown in FIG. 5, a speaker that outputs a ring tone or ring melody connected to the voice processing portion may be provided.

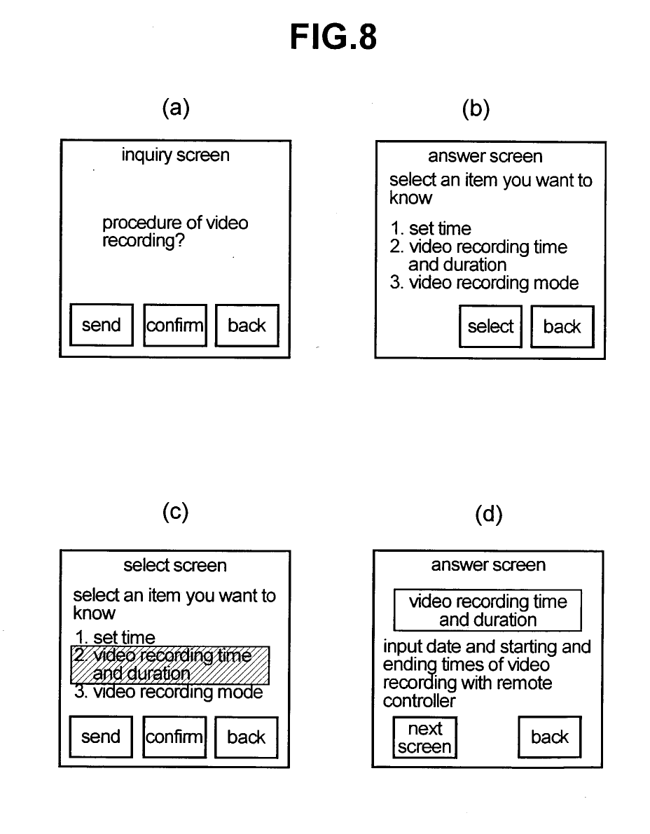

Since the mobile communications terminal 121 includes the external command transmission and status acquisition processing portion 132, it can transmit the report data set of FIG. 5(b) to a nearby electronic device by using the short-range communication function, and inquire, for example, how to use the nearby electronic device. The mobile communications terminal 121 inquiring a procedure of a timer controlled video recording is described below as an example. A user sets the mobile communications terminal 121 to an inquiry mode, inputs the inquiry item as shown in FIG. 8(a), and transmits it to the DVD recorder by using the short-range communication function. The inquiry analysis portion 116 of the DVD recorder determines that the procedure of a timer controlled video recording is requested. An answer is transmitted to the mobile communications terminal 121 by using the short-range communication function.

When the content request is not clear, a display portion 129 displays a plurality of inquiry items, as shown in FIG. 8(b), so that the user may select from the displayed items by using input keys (e.g., number keys, cursor keys or function keys, or a software keyboard ) of the mobile communications terminal 121. FIG. 8(c) shows a display screen of the display portion 129 where the user selects the “video recording time and duration” by moving a block cursor to the “video recording time and duration” item, and then presses the “confirm” key. Then, the user presses the “send” key to transmit the selected request to the DVD recorder. The DVD recorder transmits an answer for the transmitted items to the cellular phone 121, so that the display portion 129 may display an answer as shown in FIG. 8(d). When the answer is too large to be displayed on one screen, the user presses the “next screen” key. A function of displaying an answer on a data request received from other devices is described has been described above according to one embodiment of the present invention.

FIG. 5(c) shows an example of a countermeasure or answer for received report data set representing an error report and an inquiry.

In addition to the above described information display procedure of setting the time controlled video recording, there is another countermeasure (answer) for the report data set according to one embodiment of the present invention. For example, a second device lacking capacity for timer controlled video recordings forwards a request for a timer controlled video recording received from a first device to a third device, s shown in FIG. 7. In such a case, the contents of the report data set are need not changed. In the example of FIG. 7, the VCR transmits condition report data under certain circumstances, as shown in FIG. 2. In the DVD recorder which has received the condition report data, the inquiry analysis portion 116 analyzes the condition report data, and determines which device has transmitted the report data and the nature of the request in reference to the device identifier, report type identifier, operation indicating identifier and accompanying data. When it is determined that the report data contained a request for an alternative video recording (i.e., transfer request of a timer controlled video recording) from the VCR, the analysis result answer portion 115 determines whether the DVD recorder has such a recording capability by referring to the manual database. Next, based on the manual database, the analysis result answer portion 115 determines whether the DVD recorder can execute that specific video recording request referring to the video recording reservation list. The analysis result answer portion 115 deals with the alternative operation when there is no recording reservation during the requested time. When the analysis result answer portion 115 cannot deal with the alternative operation (e.g., the DVD recorder may have been requested to record another program at the same time), the received report data set is forwarded without change. When the DVD recorder performs the requested alternative operation, an indication or flag is inserted into the data set and transmitted, so that other devices do not perform duplicative functions. In this case, the steps 207, 208, 209, and 210 are executed, and thereby the data set is transmitted for a predetermined number of times.

In this embodiment, as shown in FIG. 7, the report data set includes a request that the DVD recorder cannot perform is forwarded to a hard disk recorder. The hard disk recorder performs the same decision making process as the DVD recorder. If possible, the hard disk recorder accepts an alternative operation, and if not, it transmits the report data set to another device. In the example of FIG. 7, the hard disk recorder can execute the requested operation so the timer controlled video recording is performed.

Additionally, in this embodiment, the inquiry analysis portion 116 receives and analyzes a condition report from a nearby electronic device to determine which device has transmitted the data set and nature of the device request by referring to the device identifier, the report type identifier, the operation instructing identifier, and the accompanying data, and so on.

A report transmitted as a condition report from a device is not limited to a failure or error report. For example, in FIG. 7, a report transmitted from a washing machine may contain a notification, such as “washing will be finished in three minutes”, an informative report, such as “beer is cold to drink”, or a status report, such as “ice has been made”.

As described above, according to this embodiment, a device can detect its own error and report the error to other devices having a radio communication function and within the same system. Therefore, the devices in the system cooperate with each to perform an operation requested by a user or provide useful information to the user. In the above described embodiments, the respective short-range communication portions 104 and 113 of the electronic devices 101 and 111, such as the Bluetooth, transmit and receive the report data set. However, the invention is not limited to a short range communication, and may use a long distance communication portion in other embodiments.

Many different embodiments of the invention may be constructed without departing from the spirit and scope of the invention. It should be understood that the invention is not limited to the specific embodiments described in this specification.

For example, in one embodiment, a group of similar devices (e.g., facsimile machines) provided in a distributed system may cooperate with each other to share work load. If a first facsimile machine has a queue of requests to transmit documents stored in its memory. The first machine can request condition or status reports from other machines to determine if any one of them has excess capacity. If a second machine indicates that it has an excess capacity, then the first machine transmits the transfer request with the information to be faxed to the second machine. The second machine faxes the information to an appropriate recipient, while the first machine is faxing another information, thereby fully utilizing the capacity of all the facsimile machines in the distributed system.

Accordingly, the invention is intended to cover various modification and equivalent arrangements included within the spirit and scope of the claims.

What is claimed is:

1. A method of operating an electronic device, comprising:
detecting a condition associated with the electronic device that affects a performance of an operation by the electronic device; and
transmitting a condition report to a remote electronic device, the condition report including a request to perform the operation.

2. The method of claim 1, wherein the condition report includes a device identification, a report type identification, a condition identification, and an operation identification.

3. A method of operating an electronic device system including a plurality of electronic devices, the method comprising:
detecting a condition associated with a first electronic device that affects a performance of an operation by the first electronic device; and
transmitting a first condition report to a second electronic device by the first device, the first condition report including a request to perform the operation.

4. The method of claim 3, further comprising:
performing the requested operation at the second device.

5. The method of claim 3, further comprising;
determining whether or not the second device is suitable for performing the requested operation; and
transmitting a second condition report to a third electronic device if it is determined that the second device is not suitable for performing the requested operation.

6. The method of claim 5, further comprising:
performing the requested operation at the third device.

7. The method of claim 3, wherein the condition that affects the performance of the operation by the first electronic device is a condition that prevents the first device from performing the operation.

8. The method of claim 3, wherein the condition that affects the performance of the operation by the first electronic device is a condition that delays the performance of the operation by the first device.

9. The method of claim 8, wherein the first condition report is transmitted to the plurality of electronic devices.

10. The method of claim 9, wherein at least one of the plurality of remote devices respond that the responding remote device can perform the requested operation.

11. A method of operating an electronic device, comprising:
detecting an error condition associated with the electronic device that prevents the electronic device from performing an operation; and
transmitting a condition report to a remote electronic device, the first condition report requesting the remote device to perform the operation.

12. An electronic device, comprising:
a processor to control an operation of the electronic device;
a sensor to detect a condition associated with the electronic device;
a communication interface to communicate with a remote device; and
a first memory to store computer readable instructions, the memory including code for transmitting a condition report to a remote electronic device if the sensor detects a condition associated with the electronic device that affects a performance of an operation by the electronic device, the condition report including a request to another device to perform the operation.

13. The device of claim 12, wherein the first memory is a storage device, further including code for performing the requested operation at the second device.

14. The device of claim 13, the first memory further includes:
code for determining whether or not the second device is suitable for performing the requested operation; and
code for transmitting a second condition report to a third electronic device if it is determined that the second device is not suitable for performing the requested operation.

15. The device of claim 14, the first memory further includes code for performing the requested operation at the third device.

16. The device of claim 12, further comprising:
a second memory configured to select countermeasure information according to the condition associated with the electronic device.

17. An electronic device, comprising:
a processor to control an operation of the electronic device;
a sensor to detect a condition associated with the electronic device;
a communication interface to communicate with a remote device;
a first memory to store machine readable instructions, the memory including code for transmitting a condition report to a remote electronic device if the sensor detects a condition associated with the electronic device that affects a performance of an operation by the electronic device, the condition report including a request to another device to perform the operation; and
a second memory configured to select countermeasure information according to the condition associated with the electronic device.

18. The electronic device of claim 17, wherein the device is one selected from the group consisting of, a video recording device, an audio recording device, a television, a video display device, an audio playback device, and a set-top box.

19. A machine readable medium for operating an electronic device provided in a network system including a plurality of electronic devices, the medium comprising:
code for detecting a condition associated with a first electronic device that affects a performance of an operation by the first electronic device; and
code for transmitting a first condition report to a second electronic device by the first device, the first condition report including a request to perform the operation.
